(19) United States
(12) Patent Application Publication
(10) Pub. No.: US 2007/0243278 A1
(43) Pub. Date: Oct. 18, 2007

(54) Logo embossing assembly for products such as tissues, napkins and the like

(75) Inventors: Stefano Anelli, Lucca (IT); Simone Chelossi, Lucca (IT)

Correspondence Address: MODIANO & ASSOCIATI, Via Meravigli, 16, Milan, 20123, omitted

(73) Assignee: S-TECH S.R.L

(21) Appl. No.: 11/730,781

(22) Filed: Apr. 4, 2007

(30) Foreign Application Priority Data
Apr. 14, 2006 (IT) BO2006A000292

(51) Int. Cl. B28B 3/00

(52) U.S. Cl. 425/365

(57) ABSTRACT

A logo embossing assembly for sheet products comprising at least one supporting frame for at least one embossing roller and at least one presser roller, which are arranged so as to have parallel axes substantially in mutual contact along respective generatrices and between which at least one continuous ribbon from which the sheet products are obtained can pass, the embossing roller and the presser roller being provided with respective motion transmission elements which are associated with a power-assisted rotary actuation, that is functionally controlled by at least one programmable control and processing unit adapted to perform the angular phase adjustments of the embossing roller with respect to fixed references of the continuous ribbon, so as to provide figures in relief on the products in predefined regions in relation to specific production requirements.

The present invention relates to a logo embossing assembly for sheet products, such as tissues, napkins and the like.

### BACKGROUND OF THE INVENTION

It is known that production lines of paper products such as tissues, napkins and the like are provided, generally in the initial steps of the production process, with at least one so-called logo embossing assembly, which is designed to impress in the paper products one or more figures or combinations of figures in relief.

These relief figures are provided not only for purely aesthetic purposes but mainly with the aim of increasing the thickness in certain regions of the product rather than in others, so that once said product has been folded according to a predefined pattern its thickness is substantially uniform, thus allowing packaging in packets having a regular geometry.

Traditionally, embossing assemblies of production lines are fine-tuned in the operating condition by performing predominantly manual adjustments of the mutual phase offset of the rollers that produced the relief figures on the products: this of course entails periodically stopping said lines for the time required by operators to perform said adjustments.

Modem market needs currently require ever-increasing production flexibility, i.e., the ability of lines to vary frequently the format and type of products, if possible with very short breaks. This clearly clashes with manual adjustments, which in terms of labor times and the use of workers tend to be far too expensive.

### SUMMARY OF THE INVENTION

The aim of the present invention is to obviate the drawback cited above, by providing a logo embossing assembly for sheet products such as tissues, napkins and the like which allows to perform the phase offset adjustments needed to provide relief figures on the products in preset regions in a very flexible and versatile manner and most of all without requiring manual intervention of the operators.

Within this aim, an object of the present invention is to provide a structure which is simple, relatively easy to provide in practice, safe in use, effective in operation, and has a relatively low cost.

This aim and these and other objects which will become better apparent hereinafter are achieved by the present logo embossing assembly for sheet products such as tissues, napkins and the like, of the type which comprises at least one supporting frame for at least one embossing roller and at least one presser roller, which are arranged so as to have parallel axes substantially in mutual contact along respective generatrices and between which at least one continuous ribbon from which the products are to be obtained is adapted to pass, characterized in that said embossing roller and said presser roller are provided with respective elements for mutually transmitting motion which are associated with power-assisted rotary actuation means, said means being functionally controlled by at least one programmable control and processing unit, which is adapted to perform the angular phase adjustments of said embossing roller with respect to fixed references of the continuous ribbon, so as to provide figures in relief on said products in predefined regions in relation to specific production requirements.

### BRIEF DESCRIPTION OF THE DRAWINGS

Further characteristics and advantages of the invention will become better apparent from the following detailed description of a preferred but not exclusive embodiment of a logo embossing assembly for products such as tissues, napkins and the like according to the invention, illustrated by way of non-limiting example in the accompanying drawings, wherein:

FIG. 1 is a perspective view of the embossing assembly according to the invention;

FIG. 2 is a front view of the embossing assembly;

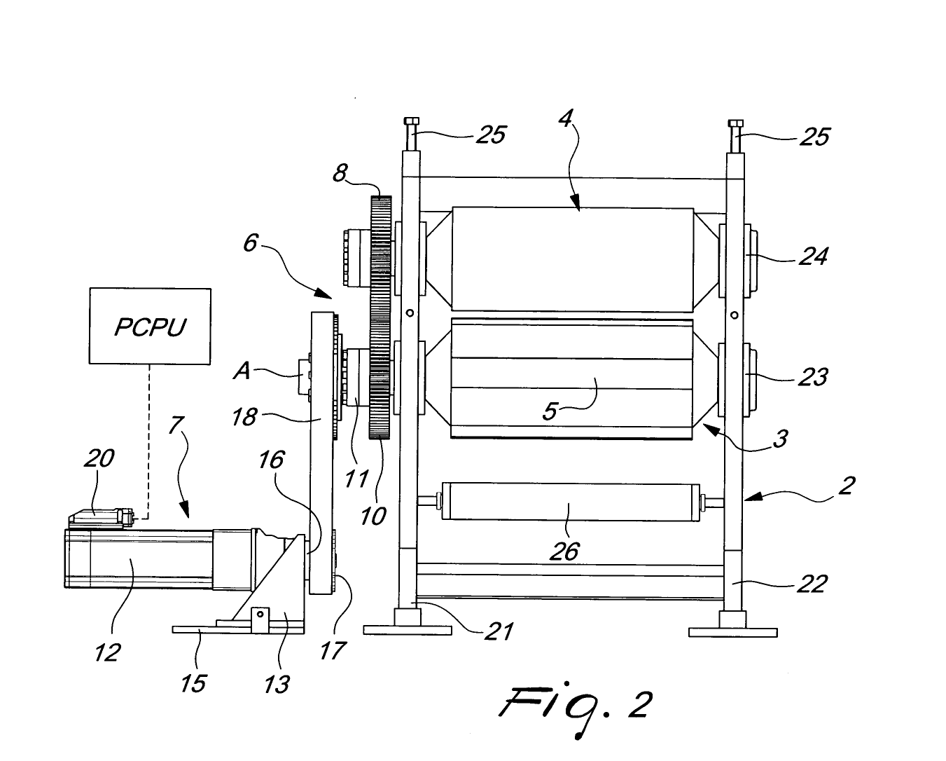

FIG. 3 is a lateral elevation view of the embossing assembly;

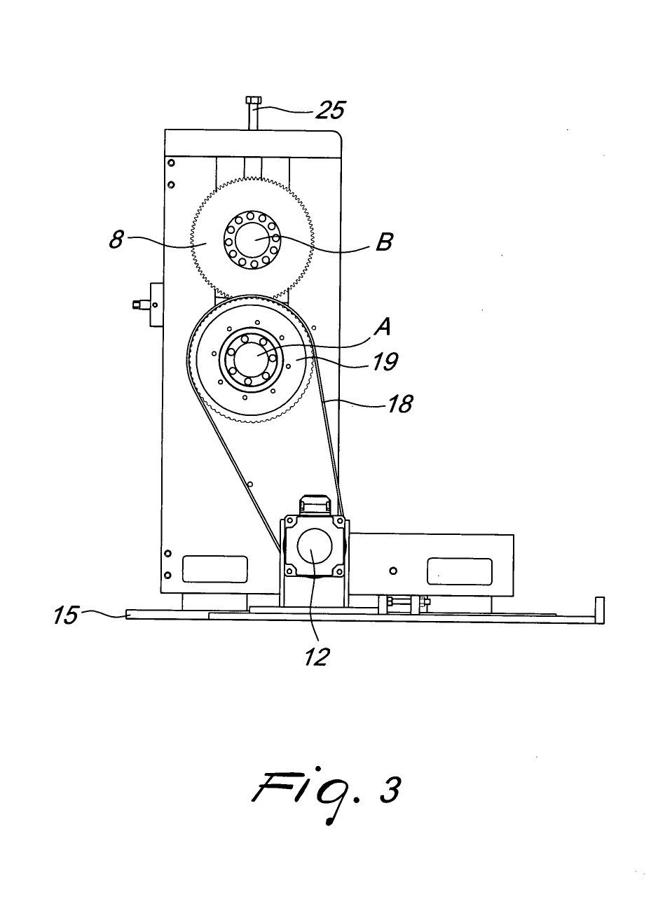

FIG. 4 is a top view of the assembly.

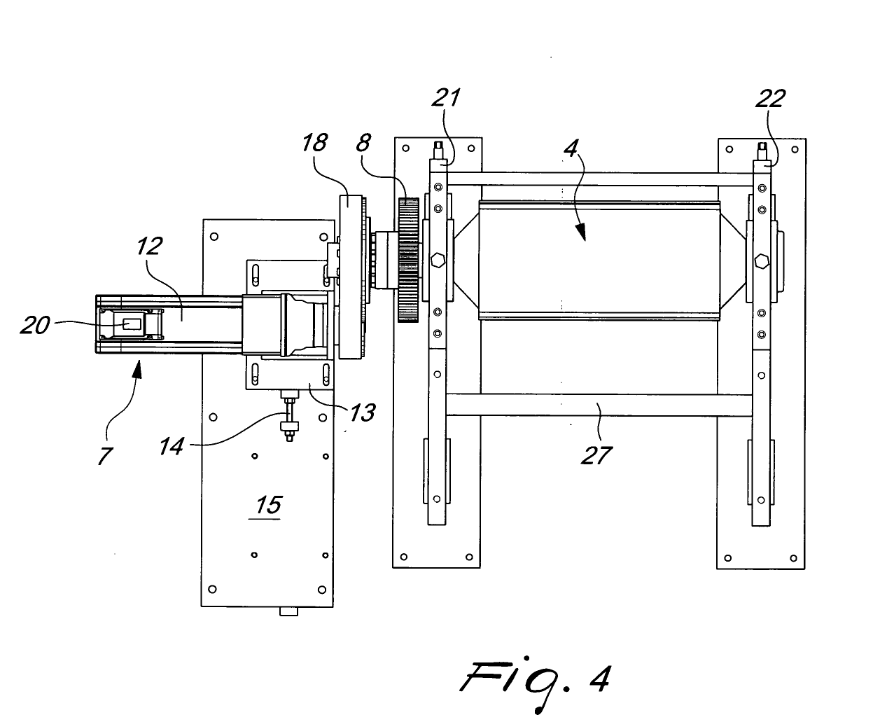

### DESCRIPTION OF THE PREFERRED EMBODIMENTS

In the exemplary embodiment that follows, individual characteristics may actually be interchanged with other different characteristics that exist in other exemplary embodiments.

Moreover, it is noted that anything found to be already known during the patenting process is understood not to be claimed and to be the subject of a disclaimer.

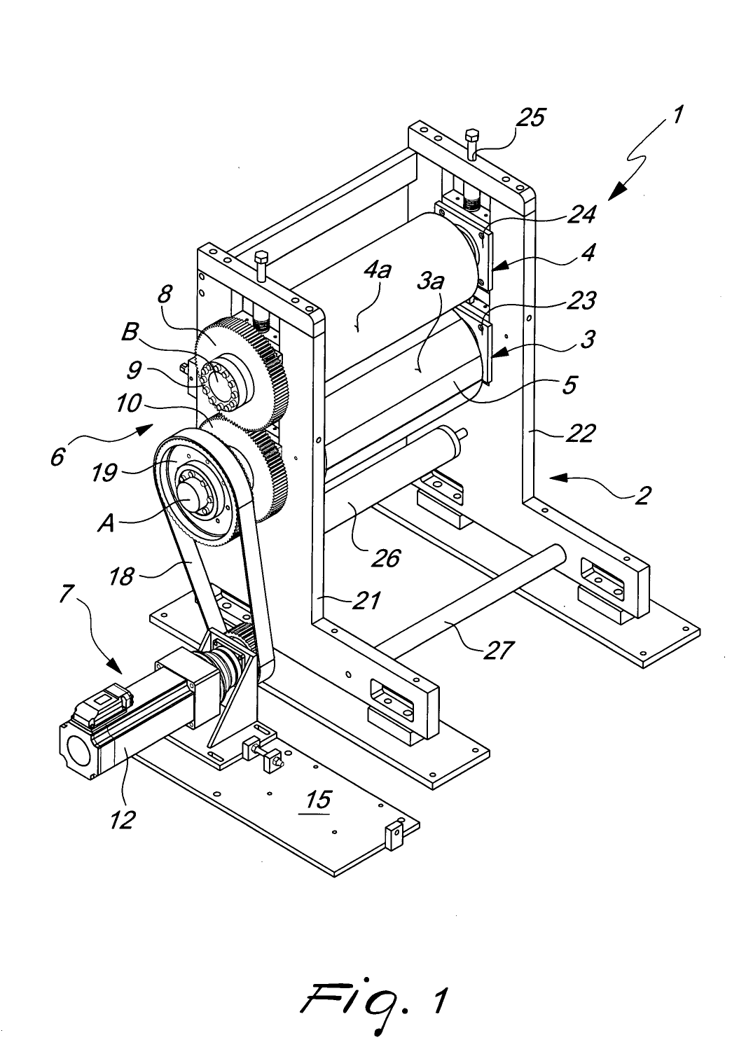

With reference to FIG. 1, the reference numeral 1 generally designates a logo embossing assembly for sheet products, such as tissues, napkins and the like according to the invention.

The embossing assembly described hereafter by way of certainly non-limiting example is of the type which comprises, in a substantially traditional manner, at least one rotary support frame with bearings, generally designated by the reference numeral 2, for at least one embossing roller 3, with a respective outer surface 3a, and at least one presser roller 4, with a respective outer surface 4a.

The embossing roller 3 and the presser roller 4 are arranged so that their axes are parallel, along a preferably horizontal direction, substantially in mutual contact along respective generatrices; at least one continuous ribbon (not shown for the sake of simplicity in the figures), made of paper-like material or the like and from which products such as tissues or napkins of the chosen size are to be obtained by means of transverse cuts, is made to pass between the embossing roller 3 and the presser roller 4.

The outer surface 3a of the embossing roller 3 is conveniently made of an appropriately chosen metallic material and is affected by relief regions 5, which are for example mutually angularly equidistant and are adapted to impress figures or combinations of figures on the continuous ribbon in predefined regions.

The outer surface 4a of the presser roller 4 is advantageously made of a substantially elastically flexible material such as rubber or the like, which deforms on contact with the embossing roller 3.

According to the invention, the embossing roller 3 and the presser roller 4 are provided advantageously with respective mutual motion transmission elements, generally designated by the reference numeral 6, which are associated with power-assisted rotary actuation means, generally designated by the reference numeral 7.

The power-assisted rotary actuation means 7 are functionally connected to at least one programmable control and processing unit PCPU, which is only schematically shown in the figures and is of a substantially known and traditional type and is adapted to perform the angular phase adjustments of the embossing roller 3 with respect to fixed references of the continuous ribbon (for example the points at which the transverse cuts are to be provided, or others), so as to provide figures in relief on the products in predefined regions, in relation to specific production requirements. Each product type in fact requires the provision of figures or combinations of figures in relief in different regions, in relation to its dimensions and to the chosen aesthetic characteristics.

The mutual motion transmission elements 6 advantageously comprise at least one first gear 8, which is keyed rigidly along the axis A of the embossing roller 3 for example by means of first keying element 9 or other similar elements, and at least one second gear 10, which is keyed rigidly along the axis B of the presser roller 4 for example by means of a second keying element 11.

The second gear 10 meshes with the first gear 8: the first gear 8 and the second gear 10 have respective numbers of teeth which are conveniently mutually prime, so that contact between the embossing roller 3 and the presser roller 4 does not occur along the same generatrices at each rotation, thus avoiding permanent surface deformations of the presser roller 4.

The power-assisted rotary actuation means 7 comprise at least one electric motor 12, which can be associated adjustably with the fixed parts of the production line such as the frame 2; in greater detail, the electric motor 12 is fixed on a bracket 13 which slides, by means of an actuation screw 14, on a plate 15 which is fixed to the floor. A driving pulley 17 is keyed on the output shaft 16 of the motor 12 and meshes with a toothed belt 18; the toothed belt 18 in turn meshes with a third gear 19, which is keyed rigidly along the axis A of the embossing roller 3. Adjustment of the position of the electric motor 12 with respect to the axes A and B respectively of the embossing roller 3 and of the presser roller 4, together with replacement of the pulley 17, of the first gear 8 and of the second gear 10, allow to vary the transmission ratio of the power-assisted rotary actuation means 7, according to the specific requirements of production (i.e., product size, positions of the reliefs thereon, and others).

The electric motor 12 is conveniently of the brushless type, is provided with connection and power supply terminals 20, and is functionally controlled by the programmable control and processing unit, which can be constituted for example by the PLC (programmable logic controller) of the tissue or napkin production line: this allows advantageously, during the preparation of the production line, to adjust, by means of the controlled rotation of the embossing roller 3 by way of a preset transmission ratio between said embossing roller and the pulley 17, the angular position of the embossing roller 3 with respect to predefined references of the continuous ribbon and obtain the figures in relief in the chosen region.

The frame 2 comprises two vertical mutually opposite shoulders 21, 22, which are fixed to the floor and are provided with respective fixed lower seats 23 for supporting, so as to allow rotation by means of bearings or the like, the ends of the embossing roller 3, and with upper seats 24, which can be adjusted by means of appropriately provided screws 25, for supporting, by way of bearings or the like, the ends of the contrast roller 4.

Further, the frame 2 supports rotatably at least one lower additional roller 26 and a tensioning roller 27, which are suitable to allow the alternative passage thereon of the continuous ribbon in the production steps in which the provision of embossing is not required.

The operation of the embossing assembly according to the invention is intuitive. In normal production conditions, the passage of the continuous ribbon through the embossing roller 3 and the presser roller 4, which are in contact along respective generatrices and are appropriately actuated so as to rotate, allows the provision of relief figures on said ribbon in predefined positions which are set in relation to exact references which are fixed along said ribbon.

In any situation in which it is necessary to vary the production conditions (for example because it is necessary to change the size of the product or because it is necessary to change the positions in the product in which the reliefs are to be provided), it is sufficient, by means of a small number of quick programming or PLC management operations, to adjust the angular position of the embossing roller 3 with respect to fixed points of the continuous ribbon by way of one or more controlled rotations of the electric motor 12.

It has thus been shown that the invention achieves the intended aim and objects.

The intervention times of the operators are reduced considerably, and so are production costs, since it is no longer necessary to provide manual adjustment of the angular position of the embossing roller with respect to the continuous ribbon.

The invention thus conceived is susceptible of numerous modifications and variations, all of which are within the scope of the appended claims.

All the details may be replaced with other technically equivalent ones.

In practice, the materials used, as well as the shapes and dimensions, may be any according to requirements without thereby abandoning the scope of the protection of the appended claims.

The disclosures in Italian Patent Application No. B02006A000292 from which this application claims priority are incorporated herein by reference.

What is claimed is:

1. A logo embossing assembly for sheet products, comprising: at least one supporting frame; at least one embossing roller; at least one presser roller, said at least one embossing and presser rollers being supported on said supporting frame with longitudinal axes thereof in a parallel arrangement and in mutual contact along respective generatrices thereof and so as to allow for at least one continuous ribbon from which the sheet products are to be obtained to pass therebetween; motion transmission elements, provided in operative connection with said at least one embossing and presser rollers for mutually transmitting motion thereto; and power-assisted rotary actuation means connected with said motion transmission elements, said rotary actuation means being functionally controlled by at least one programmable control and processing unit, which is adapted to perform angular phase adjustments of said embossing roller with respect to fixed references of a continuous ribbon, so as to provide figures in relief on the sheet products in predefined regions in relation to specific production requirements.

2. The embossing of claim 1, wherein said motion transmission elements comprise at least one first gear, which is keyed rigidly along the axis of said at least one embossing roller, and at least one second gear, which is keyed rigidly along the axis of said at least one presser roller and meshes with said at least one first gear, said at least one first gear and said at least one second gear having respective mutually prime numbers of teeth.

3. The embossing assembly of claim 2, wherein said power-assisted rotary actuation means comprise: at least one electric motor, which is associated adjustably with fixed parts of the production line and comprises an output shaft with at least one driving pulley keyed thereon; a toothed belt meshing with said at least one pulley; a third gear, which is rigidly keyed along the axis of said at least one embossing roller and which connects with said toothed belt.

4. The embossing assembly of claim 3, wherein said electric motor is a brushless motor and is functionally connected to said programmable control and processing unit so as to synchronize, by way of a controlled rotation thereof and by way of a preset transmission ratio, an angular position of said at least one embossing roller with respect to predefined references of the continuous ribbon and obtain figures in relief in selected regions.

5. The embossing assembly of claim 1, wherein said frame comprises two vertical shoulders, which are mutually opposite and are provided with respective fixed lower seats for a rotary support of said at least one embossing roller and with adjustable upper seats for rotary support of said at least one presser roller.

6. The embossing assembly of claim 5, further comprising at least one lower additional roller for providing an alternative passage for the continuous ribbon wherein execution of embossing is not required, said at least one additional roller being supported on said frame.

7. The embossing assembly of claim 1, wherein said at least one embossing roller has an outer surface made of metallic material which is provided with regions in relief which are adapted to impress figures on the continuous ribbon.

8. The embossing assembly of claim 7, wherein said at least one presser roller has an outer surface made of a substantially elastically flexible material.

9. The embossing assembly of claim 8, wherein said elastically flexible material is rubber.
